(19) United States
(12) Patent Application Publication
(10) Pub. No.: US 2013/0179634 A1
(43) Pub. Date: Jul. 11, 2013

(54) SYSTEMS AND METHODS FOR IDLE TIME BACKUP OF STORAGE SYSTEM VOLUMES

(71) Applicants: Madan Mohan Munireddy, Bangalore (IN); Prafull Tiwari, Lucknow (IN)

(72) Inventors: Madan Mohan Munireddy, Bangalore (IN); Prafull Tiwari, Lucknow (IN)

(73) Assignee: LSI CORPORATION, Milpitas, CA (US)

(21) Appl. No.: 13/344,459

(22) Filed: Jan. 5, 2012

(51) Int. Cl. G06F 12/16

(52) U.S. Cl. 711/114; 711/E12.103

(57) ABSTRACT

Methods and systems for backing up data of a RAID 0 volume. The system includes a plurality of storage devices implementing a logical volume in a Redundant Array of Independent Disks (RAID) level 0 configuration. The system also includes a storage controller. The storage controller is adapted to manage Input/Output (I/O) operations directed to the RAID 0 volume. The storage controller is further adapted to duplicate data stored on the RAID 0 volume to unused portions of other storage devices during an idle time of the storage controller.

### BACKGROUND

1. Field of the Invention

The invention relates generally to storage systems and more specifically relates to backing up a Redundant Array of Independent Disks (RAID) level 0 (striped) volume.

2. Discussion of Related Art

Storage systems typically include a large number of storage devices managed by one or more storage controllers. The storage controllers manage Input/Output (I/O) operations directed to the storage devices by one or more host systems. As processing operations at the host are typically bottlenecked by the data transfer speed of individual storage devices at the storage system, it is desirable to provide stored data as quickly as possible. In particular, Redundant Array of Independent Disks (RAID) configurations (e.g., RAID level 0) may be used to implement logical volumes that stripe data across multiple storage devices. Thus, when data for a logical volume is stored or retrieved by a storage controller, the data is transferred to/from multiple storage devices simultaneously, increasing the effective data transfer rate.

However, as the number of disks used for striping increases, the chance of one of the drives in the RAID configuration failing increases as a linear function. RAID 0 implements striping, but includes no inherent redundancy as in other RAID configurations. For example, RAID 10 volumes implement striping, and they also duplicate each incoming write operation in order to mirror every striped portion of data. In similar fashion, RAID 5 and RAID 6 configurations utilize striping, and also write additional redundancy information for each incoming write request. The redundancy information for the write request is distributed across the storage devices. In this manner, if any one drive fails, it may be rebuilt from the redundancy information on the remaining drives. RAID 5 and 6, like RAID 10, increase the number of write operations performed by the storage controller during the processing of host I/O operations and therefore decrease the overall performance of the storage controller managing the RAID volume.

To improve reliability of a RAID 0 volume, traditional backup procedures may be performed. Traditional backup procedures involve taking a “snapshot” of the volume at a point in time. During the taking of the snapshot, incoming write operations directed to the RAID 0 volume are halted, and the data on the RAID 0 volume is duplicated to another volume. Thus, the RAID 0 volume is unavailable for a period of time, which may result in problems for users desiring access. In some instances, journaling is performed during the backup to queue accumulated write operations and implement them at the RAID 0 volume after the snapshot is completed. This effectively keeps the RAID 0 volume online. Unfortunately, journaling decreases the overall performance of the storage controller managing the RAID volume because of the associated overhead processing.

Thus, it is an ongoing challenge to adequately back up data in a RAID level 0 configuration while also maintaining desired performance.

### SUMMARY

The present invention solves the above and other problems, thereby advancing the state of the useful arts, by providing methods and systems for duplicating data stored on a RAID 0 volume without substantially interfering with the operations of a storage controller managing the RAID 0 volume.

In one aspect hereof, a method is provided for duplicating data of a RAID 0 volume. The method includes managing, with a storage controller, Input/Output (I/O) operations directed to a plurality of storage devices implementing a logical volume in a Redundant Array of Independent Disks (RAID) level 0 configuration. The method further comprises determining that the storage controller is experiencing a period of idle time, and duplicating data stored on the RAID 0 volume to unused portions of other storage devices during the idle time.

Another aspect hereof provides a storage system. The storage system comprises a plurality of storage devices implementing a logical volume in a Redundant Array of Independent Disks (RAID) level 0 configuration. The storage system further comprises a storage controller adapted to manage Input/Output (I/O) operations directed to the RAID 0 volume. The storage controller is further adapted to duplicate data stored on the RAID 0 volume to unused portions of other storage devices during an idle time of the storage controller.

Another aspect hereof provides a non-transitory computer readable medium embodying programmed instructions which, when executed by a processor, are operable for performing a method. The method comprises managing, with a storage controller, Input/Output (I/O) operations directed to a plurality of storage devices implementing a logical volume in a Redundant Array of Independent Disks (RAID) level 0 configuration. The method also comprises determining that the storage controller is experiencing a period of idle time, and duplicating data stored on the RAID 0 volume to unused portions of other storage devices during the idle time.

### BRIEF DESCRIPTION OF THE DRAWINGS

FIG. 1 is a block diagram of an exemplary storage system in accordance with features and aspects hereof.

FIG. 2 is a flowchart describing an exemplary method in accordance with features and aspects hereof to duplicate data at a RAID 0 volume to unused portions of other storage devices.

FIG. 3 is a flowchart describing further details of an exemplary method in accordance with features and aspects hereof to duplicate data at a RAID 0 volume to unused portions of other storage devices.

FIG. 4 is a block diagram of an exemplary storage system implementing the methods of FIGS. 2-3 in accordance with features and aspects hereof.

### DETAILED DESCRIPTION OF THE DRAWINGS

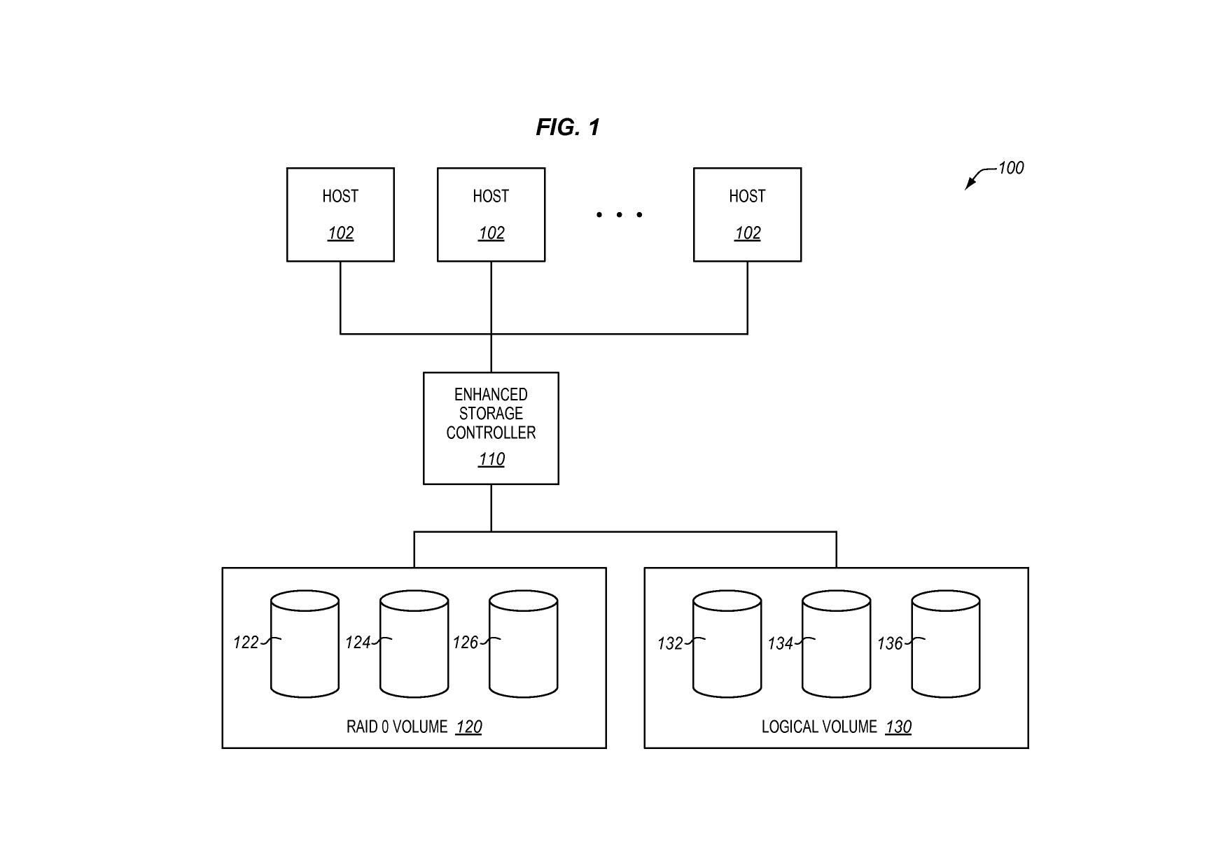

FIG. 1 is a block diagram of an exemplary storage system 100 in accordance with features and aspects hereof According to FIG. 1, enhanced storage controller 110 of storage system 100 may be used to duplicate data from RAID 0 volume 120 during idle time. In this manner, storage controller 110 may perform backup operations on RAID 0 volume 120 without experiencing a loss of performance.

Hosts 102 of storage system 100 comprise any systems, components, or devices operable to generate Input/Output (I/O) requests directed towards RAID 0 volume 120. For example, hosts 102 may comprise computer servers, home computing devices, devices with shared access to RAID 0 volume 120, etc. Hosts 102 may be communicatively coupled with storage controller 110 via one or more communication channels. The channels may be compliant for communications according to, for example, SAS, SATA, Fibre Channel, Parallel Advanced Technology Attachment (PATA), Parallel SCSI, and/or other protocols.

Storage controller 110 comprises any system, component, or device operable to manage I/O operations directed to RAID 0 volume 120. For example, storage controller 110 may be implemented as a hardware processor coupled with a non-volatile memory and one or more interfaces. Storage controller 110 may wait for an idle time, and then may duplicate some or all data from RAID 0 volume 120 into unused disk space residing on other storage devices. Storage controller 110 may be physically coupled to RAID 0 volume 120 and/or logical volume 130 (e.g., storage controller 110 may be integrated into the same physical housing or case as these volumes), or may be at a physically distinct location from these volumes. Furthermore, storage controller 110 may operate a greater or lesser number of logical volumes and storage devices than depicted with regard to FIG. 1. Storage controller 110 may be coupled with various managed storage devices via one or more communication channels. The channels may be compliant for communications according to, for example, SAS, SATA, FibreChannel, Parallel Advanced Technology Attachment (PATA), Parallel SCSI, and/or other protocols.

As is well known in the art, storage controller 110 may comprise multiple redundant systems. For example, storage controller 110 may actually comprise two linked controllers working in an active-active mode, each storage controller updating mapping structures of the other during write operations to ensure that no data conflicts occur. Furthermore, the communication channels linking the controllers to other storage system components may be redundant, and the internal memory structures used by storage controller 110 may also be redundant in order to ensure an enhanced level of reliability at storage controller 110.

RAID 0 volume 120 comprises multiple storage devices implementing a single logical volume in a RAID 0 configuration. Thus, RAID 0 volume 120 includes data that is striped across storage devices 122-126, but does not include any mirrored data or redundancy information. In practice, RAID 0 volume 120 may comprise a greater or lesser number of storage devices than depicted with regard to FIG. 1. Logical volume 130 comprises a logical volume in any format (e.g., in a RAID 5 configuration) implemented by storage devices 132-136. In practice, logical volume 130 may comprise a greater or lesser number of storage devices than depicted with regard to FIG. 1. The storage devices depicted in FIG. 1 may be implemented as optical media, magnetic media, flash memory, RAM, or other electronic recording devices. Preferably, the storage devices will comprise non-volatile storage media.

While in operation, storage controller 110 is adapted to manage I/O operations directed to RAID 0 volume 120. Storage controller 110 is further adapted to determine whether an idle time has been encountered. An idle time includes periods in which storage controller 110 has no queued write commands for logical volumes (e.g., RAID 0 volume 120), and further is not currently processing write commands for logical volumes. If storage controller 110 determines that an idle time has been reached, storage controller 110 is adapted to identify unused portions of storage devices that do not implement RAID 0 volume 120. This may occur, for example, by storage controller 110 reading a mapping structure (e.g., an array, hash table, or other data structure) stored in memory that indicates unused portions of volume 130. Storage controller 110 may then duplicate data stored at RAID 0 volume 120 into these unused portions of the storage devices implementing volume 130. Note that an unused portion of the other storage devices may include space allocated/reserved for another logical volume, so long as the space does not include stored data for that other logical volume. As data is duplicated from RAID 0 volume 120 to the unused portions, storage controller 110 may update the mapping structure in order to indicate what data from RAID 0 volume 120 has been stored, as well as the addresses at which the data has been stored. Thus, RAID 0 volume 120 (or portions thereof) may be easily rebuilt from the duplicated data by using the mapping table.

Furthermore, storage controller 110 may be adapted to determine that an incoming write operation will overwrite data previously duplicated from RAID 0 volume 120 with data for logical volume 130. In this scenario, storage controller 110 may update the mapping structure to indicate that the previously duplicated data has been overwritten, and may further select a new unused portion at which to store the overwritten data. In one embodiment, incoming write commands that will overwrite data previously duplicated from RAID 0 volume 120 with data for logical volume 130 are redirected to other unused portions of logical volume 130. This process continues until the only available spaces for logical volume 130 are the unused portions that currently store duplicated data for RAID 0 volume 120. At this point, further incoming write commands for logical volume 130 overwrite the duplicated data.

Implementing the above system results in a number of benefits. First and foremost, RAID 0 volume 120 exhibits a greater level of data integrity than a normal RAID 0 volume because its data is duplicated to other locations and the duplicated data is tracked via a mapping structure. Thus, if one disk of RAID 0 volume 120 fails, it may be at least partially reconstructed from the duplicated data. An additional benefit of RAID 0 volume 120 is that the backup process does not over-encumber storage controller 110. Rather, storage controller 110 performs backup functions during idle time, so host I/O operations for storage controller 110 are not interrupted.

Additionally, RAID 0 volume 120 does not reduce the amount of free space in storage system 100 as the backup is performed. The other storage devices are free to overwrite the duplicated data stored in their free space (i.e., no space needs to be allocated for the duplicated data of RAID 0 volume 120). Thus, as the stored data for other logical volumes grows at the storage devices, it is possible that the other logical volumes will “reclaim” their previously unused space.

The backup process for RAID 0 volume 120 takes into account the understanding that most storage devices and logical volumes are underutilized. That is to say, most storage devices and/or logical volumes never use more than a certain fraction (e.g., 80-90%) of their available space. The duplicated data of RAID 0 volume 120 may therefore “hide” in this unused space, where it may be overwritten if necessary, but remains unlikely to be overwritten.

Furthermore, the duplicated data for RAID 0 volume 120 can be provided (e.g., to some degree in place of the original data) when an incoming read request is received. This provides a benefit because it may increase the number of disks providing data to the host and therefore increase the throughput of the storage system.

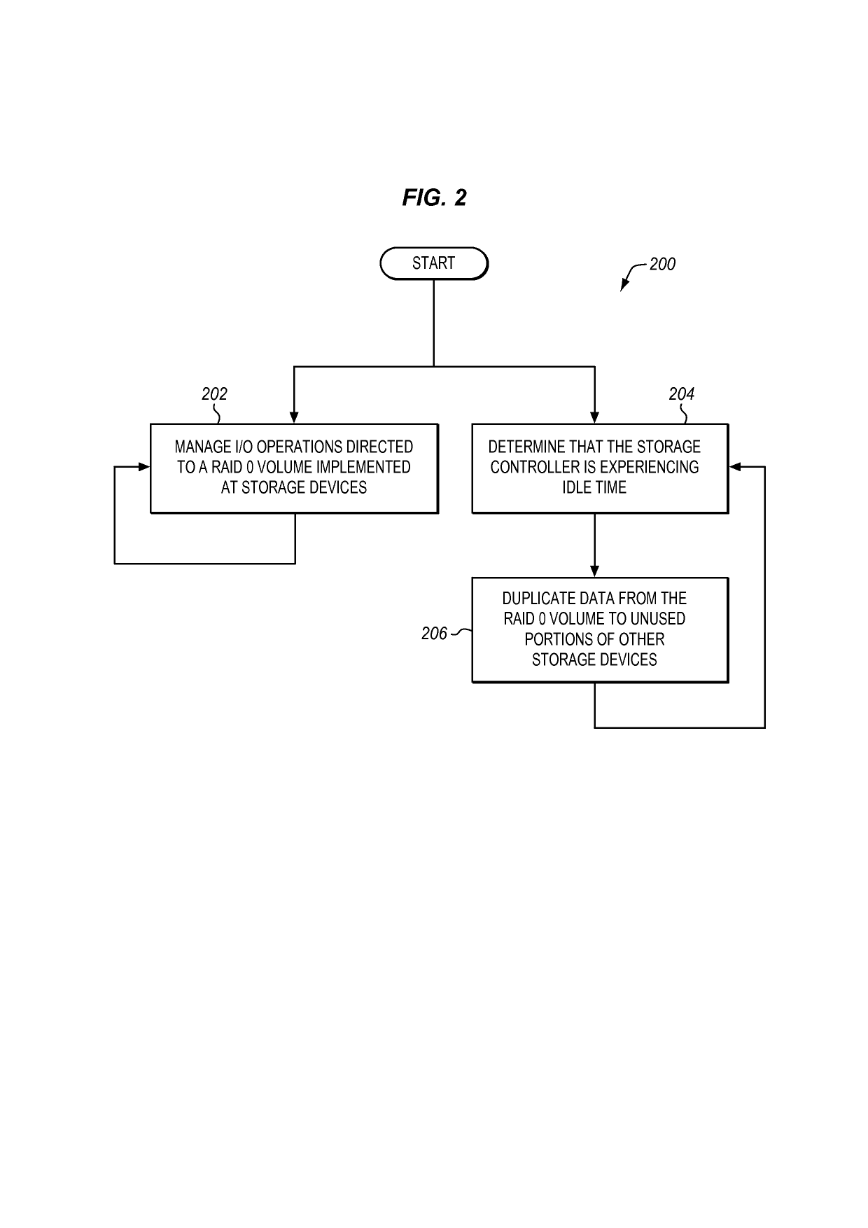

FIG. 2 is a flowchart describing an exemplary method 200 in accordance with features and aspects hereof to duplicate data at a RAID 0 volume to unused portions of other storage devices. The method 200 of FIG. 2 may be operable in a storage system such as described above with regard to FIG. 1.

Step 202 describes that a storage controller manages Input/Output (I/O) operations directed to a RAID 0 volume implemented at multiple storage devices. These I/O operations may be provided by a host or may be part of the normal operations of storage controller 110 as it manages the storage devices of the RAID 0 volume (e.g., integrity checks, defragmentation operations, etc.).

In step 204, the storage controller determines that it is experiencing idle time. This determination may be made by the storage controller checking an internal queue to see if any I/O requests from the host remain to be processed. If I/O requests remain to be processed, then the storage controller is not idle. However, if the storage controller does not have any I/O requests to process, it may be considered idle.

In step 206, the storage controller duplicates data from the RAID 0 volume to unused portions of other storage devices. Thus, the data from the RAID 0 volume is backed up to another location without effectively interrupting the active operations of the storage system. Additionally, no free space is lost in the backup operation, as the space used for the backup may still be overwritten at the other storage devices. Note that other storage devices may include, for example, disks for other RAID volumes, dedicated hot spares, global hot spares, unconfigured “good” drives, etc. In one embodiment, an internal mapping structure at the storage controller is used to indicate the addresses/locations of specific segments of data duplicated from the RAID 0 volume. Thus, as the data is duplicated, its location at the other storage devices is marked. When the other storage devices overwrite the duplicated data, the mapping structure can be updated to indicate that the duplicated data at this location is no longer valid. Similarly, if data for the RAID 0 volume is changed, the duplicated data at the other storage devices may no longer be valid, in which case the duplicated data may be marked as “dirty” data in the same or a different mapping structure. The mapping structure may be stored and maintained, for example, in firmware residing in non-volatile RAM for the storage controller. Note that if the storage controller manages the other storage devices on which the duplicate data is stored, it may be a simple matter of checking received write requests against the mapping structure to see if the duplicated data is going to be overwritten. However, if the other storage devices are managed by another storage controller, it may be desirable to request notifications from the other storage controller whenever duplicated data for the RAID 0 volume has been overwritten.

In a further embodiment, the storage controller may determine that data duplicated from the RAID 0 volume to the other storage devices has become fragmented due to overwriting. Therefore, the storage controller initiates a defragmentation process, wherein previously split blocks of duplicated data are coalesced as continuous sets of locations at the unused portions.

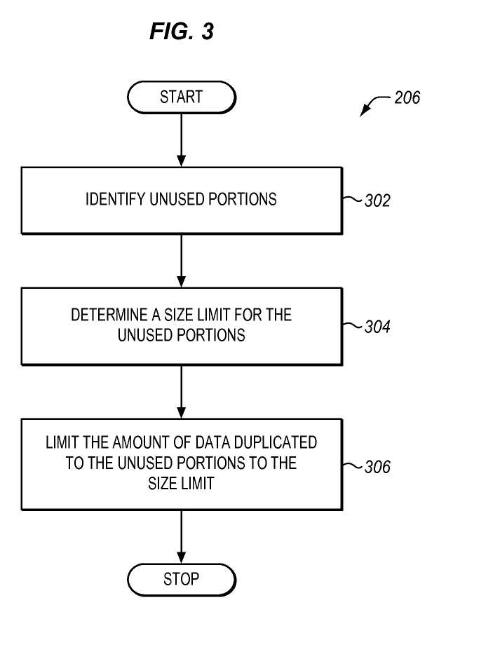

FIG. 3 is a flowchart describing further details of an exemplary method in accordance with features and aspects hereof to duplicate data at a RAID 0 volume to unused portions of other storage devices. FIG. 3 illustrates further steps that may be implemented at step 206 of method 200 of FIG. 2, wherein the data for the RAID 0 volume is duplicated to unused portions of other storage devices. In particular, FIG. 3 illustrates a scenario wherein a storage controller ensures that no more than a certain amount of space is used at the other storage devices.

In step 302, the storage controller identifies unused portions of a storage device. An unused portion includes a portion that does not currently include data written for another logical volume. An unused portion of a storage device may be identified, for example, by checking a mapping table to determine whether a user or host has stored data at a given logical block address (or set of logical block addresses) of a storage device. Note that in the storage system used by the storage controller, there may be multiple unused portions available, residing on the same or different storage devices.

As discussed above, most storage devices are underutilized, and only use a certain percentage of their storage space throughout their lifetime. This fraction varies (e.g., 70%, 80%, 90%), but typically a not insignificant amount of space “lies fallow” at the storage device, even when the space is allocated to a given logical volume. Thus, it is possible to use the unused portions of the storage device to duplicate data for the RAID 0 volume and to still somewhat reliably expect that those portions will not be overwritten.

At the same time, it may be important not to overuse the free space on a given storage device. For example, if a newly initialized storage device is almost entirely free space, it may be logical to expect that the storage device will eventually be filled with data until it has only, for example, 9-10% free space. Therefore, it would be unwise to use all of the unused space, because most of the unused space is likely to be used in the near future. To address this and similar situations, a threshold/limit may be used to ensure that data from the RAID 0 volume is not duplicated to one storage device or volume to the extent that it is likely to be overwritten.

Step 304 includes the storage controller determining a size limit for the identified unused portions. The limit will typically be defined as a fraction of the overall size of the storage space (i.e., the capacity) of the storage device that will be storing the duplicated data of the RAID 0 volume. In one embodiment, the size limit is a fraction of the overall size of the logical volume to which the unused portion has been allocated. Fixed limits and formula-based limits are also possible.

Additionally, the size limit is likely to vary greatly depending on the intended use of the storage device. For example, a hot spare is likely to consistently have all of its space available for backup purposes (because no space on the hot spare is likely to be used except in the relatively rare event of a disk failure). In contrast, a storage device implemented as a part of a RAID 5 volume may be expected to have only, for example, 10% of its total free space available for duplicated data from the RAID 0 volume.

Step 306 includes limiting/restricting the amount of data duplicated to the unused portions to the size limit. Data beyond the limit may be sent to an unused portion of another storage device. In this manner, a given storage device and/or logical volume is not over-filled with duplicated data from the RAID 0 volume.

In a related embodiment to that discussed with regard to FIG. 3, the storage controller is adapted to move duplicated data off of a storage device whenever the storage device hits a minimum amount of free space. This may be performed in anticipation that the duplicated data on the storage device will be overwritten. For example, if duplicated data occupies the last 10% of a storage device's capacity, the storage controller may start moving the duplicated data to a new location when the storage device gets 80% full. The move is performed in anticipation of the storage device getting so full that it will overwrite the duplicated data.

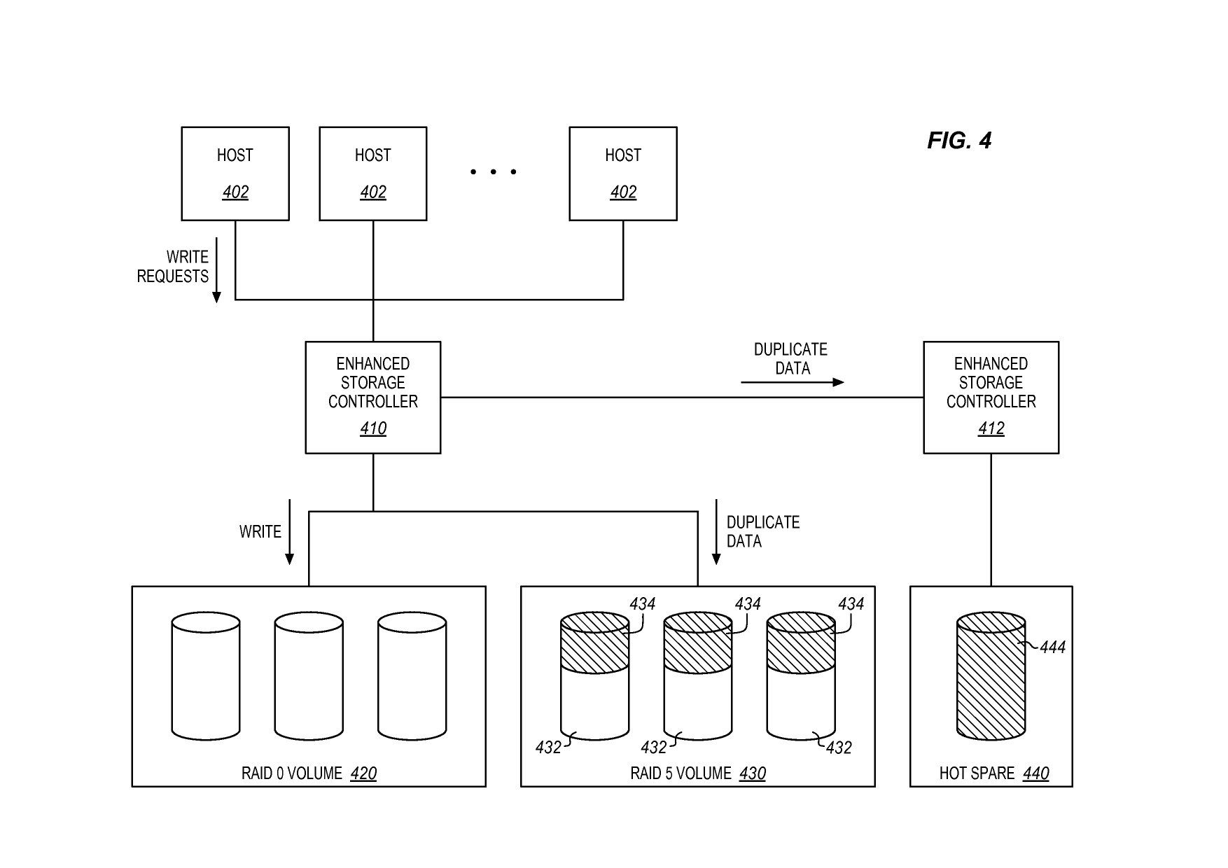

FIG. 4 is a block diagram of an exemplary storage system implementing the methods of FIGS. 2-3 in accordance with features and aspects hereof. According to FIG. 4, hosts 402 provide data to enhanced storage controller 410 for writing to RAID 0 volume 420 and RAID 5 volume 430. Storage controller 410 waits for idle time, and during idle time, storage controller 410 duplicates data to unused portions of RAID 5 volume 430 and hot spare 440. In this embodiment, portions 432 of RAID 5 volume 430 store data for RAID 5 volume 430, while unused portions 434 do not include stored data. Therefore, during idle time, storage controller 410 duplicates data from RAID 0 volume 420 to unused portions 434. Additionally, storage controller 410 ensures that no more than 10% of a given storage device of RAID 5 volume 430 is filled with data duplicated from RAID 0 volume 420. Storage controller 410 furthermore maintains and updates an internal mapping structure in order to track the location and identity of data duplicated from RAID 0 volume 420.

Similarly, during idle time storage controller 410 identifies hot spare 440 accessible via Remote Direct Memory Access (RDMA) with enhanced storage controller 412. In this embodiment, storage controller 412 is located at the same storage system, but at a different storage subsystem than storage controller 410. Because hot spare 440 is not currently intended for data storage, unused portion 444 of hot spare 440 comprises all of hot spare 440. Storage controller 410 may determine that, because hot spare 440 is a hot spare, it is likely that data stored at hot spare will not be overwritten except in the unlikely scenario of a disk failure at the storage system. Therefore, storage controller 410 uses all 100% of unused space at hot spare 440 for storing duplicated data from RAID 0 volume 420.

Storage controller 410 further requests that storage controller 412 report back to storage controller 410 whenever portions of hot spare 440 become used by another logical volume. For example, storage controller 410 may request that if hot spare 440 becomes used by another logical volume, that storage controller 412 report back memory locations (previously storing duplicated data for RAID 0 volume 420) that have been overwritten. Storage controller 410 may then update an internal mapping structure to reflect these changes.

While the invention has been illustrated and described in the drawings and foregoing description, such illustration and description is to be considered as exemplary and not restrictive in character. One embodiment of the invention and minor variants thereof have been shown and described. In particular, features shown and described as exemplary software or firmware embodiments may be equivalently implemented as customized logic circuits and vice versa. Protection is desired for all changes and modifications that come within the spirit of the invention. Those skilled in the art will appreciate variations of the above-described embodiments that fall within the scope of the invention. As a result, the invention is not limited to the specific examples and illustrations discussed above, but only by the following claims and their equivalents.

What is claimed is:

1. A storage system comprising:
a plurality of storage devices implementing a logical volume in a Redundant Array of Independent Disks (RAID) level 0 configuration; and
a storage controller adapted to manage Input/Output (I/O) operations directed to the RAID 0 volume, the storage controller further adapted to duplicate data stored on the RAID 0 volume to unused portions of other storage devices during an idle time of the storage controller.

2. The storage system of claim 1, wherein:
the storage controller is further adapted to detect unused portions of the other storage devices by determining whether logical block addresses of the other storage devices include stored data.

3. The storage system of claim 1, wherein:
the storage controller is further adapted to limit the amount of data duplicated to identified unused portions.

4. The storage system of claim 3, wherein:
the limit comprises a percentage of a total size of a storage device at which the identified unused portions are located.

5. The storage system of claim 1, wherein:
the storage controller is further adapted to determine that an identified unused portion has become used for storing data for another logical volume, and to write data previously duplicated to the identified portion to another unused portion.

6. The storage system of claim 1, wherein:
the unused portions include space that has been allocated for one or more other logical volumes and that does not include stored data for the other logical volumes.

7. The storage system of claim 6, wherein:
the data duplicated to the unused portions is not mapped at the one or more other logical volumes.

8. The storage system of claim 1, wherein:
the idle time comprises a period of time during which there are no queued I/O commands for the storage controller, and the storage controller is not currently processing an I/O command.

9. The storage system of claim 1, further comprising:
a memory adapted to store mapping data indicating the unused portions which are currently storing duplicated data, wherein
the storage controller is further adapted to maintain the mapping data at the memory.

10. A method comprising:
managing, with a storage controller, Input/Output (I/O) operations directed to a plurality of storage devices implementing a logical volume in a Redundant Array of Independent Disks (RAID) level 0 configuration;
determining that the storage controller is experiencing a period of idle time; and
duplicating data stored on the RAID 0 volume to unused portions of other storage devices during the idle time.

11. The method of claim 10, further comprising:
detecting unused portions of the other storage devices by determining whether logical block addresses of the other storage devices include stored data.

12. The method of claim 10, further comprising:
limiting the amount of data duplicated to identified unused portions.

13. The method of claim 12, wherein:
the limit comprises a percentage of a total size of a storage device at which the identified unused portions are located.

14. The method of claim 10, further comprising:
determining that an identified unused portion has become used for storing data for another logical volume; and
writing data previously duplicated to the identified portion to another unused portion.

15. The method of claim 10, wherein:
the unused portions include space that has been allocated for one or more other logical volumes and that does not include stored data for the other logical volumes.

16. The method of claim 15, wherein:
the data duplicated to the unused portions is not mapped at the one or more other logical volumes.

17. The method of claim 10, wherein:
the idle time comprises a period of time during which there are no queued I/O commands for the storage controller, and the storage controller is not currently processing an I/O command.

18. The method of claim 10, further comprising:
storing mapping data at a memory indicating the unused portions which are currently storing duplicated data; and
updating the mapping data at the memory.

19. A non-transitory computer readable medium embodying programmed instructions which, when executed by a processor, are operable for performing a method comprising:
managing, with a storage controller, Input/Output (I/O) operations directed to a plurality of storage devices implementing a logical volume in a Redundant Array of Independent Disks (RAID) level 0 configuration;
determining that the storage controller is experiencing a period of idle time; and
duplicating data stored on the RAID 0 volume to unused portions of other storage devices during the idle time.

20. The medium of claim 19, wherein the method further comprises:
detecting unused portions of the other storage devices by determining whether logical block addresses of the other storage devices include stored data.
